(19) United States
(12) Patent Application Publication
(10) Pub. No.: US 2021/0037720 A1
(43) Pub. Date: Feb. 11, 2021

(54) APPARATUS FOR PLACING WIRE FASTENERS

(71) Applicant: PELLENC, Pertuis (FR)

(72) Inventors: Bernard LOPEZ, La Tour D'Aigues (FR); Nicolas CHAUDET, Pertuis (FR); Philippe GILBERT, Le Puy Sainte Reparade (FR)

(21) Appl. No.: 16/964,054

(22) PCT Filed: Mar. 4, 2019
(86) PCT No.: PCT/FR2019/050475

§ 371 Date: Jul. 22, 2020

(30) Foreign Application Priority Data
Mar. 20, 2018 (FR) 1870309

(51) Int. Cl. A01G 17/08

(52) U.S. Cl. CPC A01G 17/085

(57) ABSTRACT

Disclosed is an apparatus for placing wire fasteners. The apparatus includes: a wire guide, a pivoting hook forming a section of the wire guide, a mechanical feeder of fastening wire, a blade for cutting the wire, a rotary twister, a single electric motor, a transmission mechanism having a wheel for sequential actuation of the hook and the blade, a first sensor of the angular position of the sequential actuation wheel, and an electronic circuit for controlling the electric motor connected to the first angular position sensor. The first angular position sensor is a continuously variable signal sensor that is sensitive to a rotation of the sequential actuation wheel over an angular range of 360 degrees. The apparatus can be used in the field of viticulture and arboriculture.

### FIELD OF THE INVENTION

The present invention relates to an apparatus for placing wire ties.

Such an apparatus, still called a “tying gun,” is used for the attachment of small branches or shoots of trees, shrubs or bushes to each other, or even for the attachment of vine canes onto a thin support and in particular onto a training wire.

The attachment is done by means of a tie wire positioned and twisted by the tying gun.

In the viticulture field, the attachment of vine shoots and canes onto training supports is a time-consuming annual operation requiring the placement of a large number of ties. The number of ties to be placed can vary from 9000 to 80,000 ties per hectare of plants.

The main applications of the invention are in the fields of arboriculture culture and viticulture.

### DESCRIPTION OF THE RELATED ART

An illustration of the state-of-the-art is given by the patent EP 0,763,323.

The patent EP 0,763,323 relates to a tying gun provided with a single actuation electric motor supplied with direct-current. The tying gun forms a twisted tie around elements to be tied during a tying cycle initiated by an operator pressing on a trigger of the gun. The motor provides mechanical actuation of a tie placement head of the gun for the functions of preparation of a tie from tie wire and for an operation consisting of twisting the tie wire after placement thereof around the elements to be tied.

The tie placement head of the gun comprises a pivoting hook which constitutes a segment of a tie wire guide. In order to go around the elements to be attached, the hook can pivot between an open position allowing the passage of the elements to be attached into the placement head and the closed position in which twisting of the tie wire around the elements to be tied is possible.

The motor is connected to a complex transmission mechanism for performing the main functions of the tying cycle, specifically feeding the tie wire, closing the hook, cutting the tie wire, rotating the twister and finally opening the hook.

The transmission mechanism comprises a sequential actuation wheel which serves during rotation thereof through a full turn to cause the closure of the hook, actuation of the feed roller for the tie wire, actuation of the blade and opening of the hook. The sequential movement of the actuation wheel is transmitted to the various components either by a set of gears, for the feed roller, or by a set of cams and links for the hook and the blade. The set of cams and links actuating the hook comprises a presser roller engaging with the feeding roller for engaging and disengaging the advancing of the tie wire.

The transmission mechanism also comprises a twister to twist the tie wire around the elements to be tied.

The sequential actuation wheel and the twister are coupled to the motor via respectively freewheel and opposite direction transmissions. In that way, for a rotation of the motor in a first rotation direction, only the sequential actuation wheel is driven, whereas the twister remains at rest. In contrast, for rotation of the motor in a rotation direction opposite the first rotation direction, only the twister is driven whereas the sequential actuation wheel remains at rest.

The selective driving of the sequential actuation wheel and of the twister occurs by an action on the command of the electric motor. An electronic supply and command circuit for the motor is provided for this purpose for driving the rotation direction and rotation speed of the motor in the first rotation direction and in the opposite rotation direction.

The sequential actuation wheel comprises two indexing magnets positioned at predetermined angular positions. During the passage of an indexing magnet in front of a Hall effect sensor, an instantaneous signal is sent to the command circuit for the motor in order to initiate changes in the command settings for the motor (e.g. rotation speed, direction).

It is similar with the twister which comprises two symmetrically arranged indexing magnets that during the rotation of the twister pass successively before a Hall effect sensor in order to generate an instantaneous signal to the command circuit for the motor and to initiate there as well changes in the command settings for the motor (e.g. rotation speed, direction).

The first difficulty resides in the positioning of the indexing magnets requiring precise machining, precision related to the setting for the motor initiated during the instantaneous signal triggered by the passage of the magnet before the Hall effect sensor.

The angular arrangements of the indexing magnets for the sequential actuation wheel and for the twister serve to initiate different phases of the tying cycle in one full turn of the sequential actuation wheel and it is not possible to generate a signal to the command circuit of the motor outside of these positions.

For example, a specific command for stopping the motor when the feeding of the tie wire is disengaged would require the placement of an additional indexing magnet on the sequential actuation wheel, but would also require that this magnet generate a distinct signal from that generated by the other indexing magnets acting during the tying cycle so that the signal thereof is masked by the electronic command circuit for the motor during execution of the tying cycle. Thus, the implementation of other functions than the tying cycle would require the multiplication of supplemental indexing magnets, with each of these magnets generating a distinct signal on passage thereof before the Hall effect sensor, masked during execution of the tying cycle, and multiplying the complexity of implementation of the tying gun. This operation, while indispensable for maintenance of the tool and changing the line, is done manually with lots of effort.

Another problem relates to the inertia of the system at the time of the detection of a preset angular position. For example, when it stops, the twister needs to be precisely positioned relative to the tie wire guide to allow the unrestricted passage of the tie wire during the next tying cycle before rotating the twister. During rotation of the twister, inertia thereof does not make it possible to stop it in the desired angular position with sufficient precision. The motor is then first stopped and then repowered for turning at a rotation speed strongly limiting the inertia of the twister so as to stop the twister in the preset position thereof on detection of the following indexing magnet. This phenomenon is even more important when the speed of the motor is fast.

### BRIEF DESCRIPTION OF THE INVENTION

In the following, the terms “upstream” and “downstream” are understood relative to a direction of advancing of a tie wire along a wire path from an inlet of the tie wire to an end of the wire guide in the tie placement head.

The known operation of the tie gun, described above, serves during a press on the trigger to execute a full tying cycle because of the detection of preset angular positions of the sequential actuating wheel or of the twister. On the other hand, it does not allow a specific action of the operator for automatically stopping the tool in positions in between these preset positions, allowing specific positioning of these components to facilitate maintenance operations or addition of a new tie wire, for example.

Nor does operation of the known tie gun allow instantaneous stopping of the tool in a preset position upon detecting such a position. Further, if such a stop were possible, it would be sudden and would be detrimental to the durability of the mechanical components of the tool by leading to their premature wear, which could greatly limit the lifetime of the tool.

Thus, it is important to be able, both, to define new angular positions, distinct from the preset angular positions of a full tying cycle, and also to anticipate the arrival in any angular position with a precision which could be of order of one degree of angle, so that the setting for the motor is met at the exact moment of the passage through this angular position.

To overcome these difficulties, the invention more precisely proposes a tie placement apparatus, comprising:
a wire guide, for tie wire, extending between a wire inlet and a fixed guide end;
a pivoting hook having one free hook end, where the hook forms a segment of the wire guide and pivots freely between an open position in which the free hook end is separated from the fixed guide end, and a closed position in which the free hook end is aligned with the fixed guide end;
a mechanical tie wire feeder disposed upstream from the hook;
a wire severing blade, where the blade is arranged downstream from the hook;
a rotary twister with tie wire feeders arranged upstream and downstream from the hook, and downstream from the blade, where the feeders are configured for intercepting a tie wire in an alignment position of the rotary twister with the wire guide;
an electric motor connected to a transmission mechanism comprising a sequential actuation wheel for the hook and the blade;
a first angular position sensor of the sequential actuation wheel, configured for delivering a first continuously variable angular position signal over a 360° angular range of rotation of the sequential actuation wheel, where the first angular position sensor is associated with at least one among the sequential actuation wheel and the electric motor;
an electronic command circuit for the electric motor connected to the first angular position sensor and receiving the first angular position signal from the angular position sensor, in order to drive the motor as a function of said first angular position signal.

The tie wire may comprise at least one metal wire, preferably sleeved, for example a soft steel or stainless-steel wire arranged between two ribbons of paper or plastic material. The wire reserve can be formed by a coil, for example a coil carried on the belt of a user or on the gun. The tie wire is inserted into the tie placement apparatus by a rear wire inlet turned towards the user.

The tie wire is then routed in the tie placement apparatus along a guide, from the wire inlet to a fixed guide end.

The major functional segment of the wire guide is formed by an arc-shaped hook for being positioned around the elements to be tied. The hook has two ends including a first end which can be connected to the body of the placement apparatus by a pivot link and a second end, free, towards which the tie wire is directed. It can also come in a form pivoting around a central axis as in the document EP 1,114,578. The hook is part of the tie placement head of the apparatus.

In a position of the hook called “open,” the free end of the hook is away from the fixed guide end, and also away from the subsequently described twister. The open position of the hook provides a passage for receiving the elements to be tied into the tie placement head. Typically, it involves a vine shoot or cane and training wire.

In the open position, a path for the tie wire in the placement head is interrupted. The path is then reestablished when the hook is in a position called “closed.” In the closed position, the free end of the hook is adjacent to the fixed guide end and aligned therewith. A continuous path for the tie wire is thus defined.

The advancing of the tie wire along the path is provided by an advancing feeder. The advancing feeder may comprise a mechanical feeding roller upstream from the hook. More precisely, the tie wire can be pinched between the feeding roller and a presser roller and fed by the feed roller. Preferably, the roller is provided with notches which compress into the line for improving the feeding without slipping.

According to another possibility, the advancing feeder for the wire can also comprise a sliding jaw sequentially grasping the tie wire in a distal position relative to the hook and releasing it in a proximal position.

As previously indicated, the tie placement head also comprises a blade for cutting the tie wire after advancement thereof out of the fixed end of the guide. Cutting of the tie wire in segments of a certain length, extending from the blade to the fixed end of the guide, serves to form uniform length ties.

The blade can be formed, for example, by a rotating guillotine.

Another essential component in forming the ties is the rotary twister. The twister intercepts the tie wire near the free ends thereof, meaning near the end found in the fixed guide end and the end found near the blade, after cutting. Rotation of the twister and more specifically that of the tie wire feeders of the twister serves to rotationally bind the free ends of the tie wire and to make a twist with which to tighten the tie around the elements to be tied.

The mechanical energy necessary for the operation of the various organs of the tie placement apparatus can be provided by one or more electric motors, where each of them is associated with at least one function of the tool among feeding the line, pivoting the hook, cutting the tie wire and twisting it. The one or more electric motors can be supplied with energy by a battery incorporated in the tie placement apparatus or carried by the user. The battery can be driven by the electronic circuit which also commands the motors.

The transmission mechanism connects each motor to the one or more actuators thereof and the transmission mechanism of the at least two functions of closure of the hook and cutting of the tie wire comprises a sequential actuation wheel.

The sequential actuation wheel is provided with some number of actuation cams. The cams engage with the links for the command of the blade and pivoting of the hook. A detailed description of the operation of the cam and link system can be found in the document EP 0,763,323.

The electric motor associated with the transmission mechanism for the sequential actuation wheel is associated with an electronic command circuit with which to drive the electrical supply for the phases of the motor. There are preferably three phases when it involves a permanent-magnet brushless three-phase synchronous motor, called “brushless” motor. This type of motor is preferred when it involves generating high working speeds and saving energy from the battery because of the high yield thereof. Especially, without brushes, friction is completely eliminated and the life of the motor is lengthened.

The electronic command circuit can in particular set the rotational direction of the motor and the rotational speed of the motor in each direction with phases for acceleration, holding a rotation speed and deceleration. The electronic command circuit can also serve to coordinate, command and pilot the functions of the various motors of the tool when the tool comprises several electric motors. The electronic command circuit receives the first angular position signal and determines the instantaneous current or voltage parameters applied successively to the phases of the motor for commanding an instantaneous rotation speed of the motor. In particular, the electronic circuit calculates and applies the frequency of the supply current for successive phases of an electric motor when it involves a permanent-magnet brushless three-phase synchronous motor. The first angular position signal is a signal which could reflect the instantaneous angular position of the sequential actuation wheel.

The first angular position signal is issued by a first angular sensor of the sequential actuation wheel.

It is just the same appropriate to specify that the first angular position sensor is not necessarily associated with the sequential actuation wheel but can also be associated with the electronic motor driving the sequential actuation wheel, or generally with any axis of rotation, or component in rotation, mechanically linked to the rotation of the sequential actuation wheel with a known reduction or multiplication factor.

Thus, the first angular position sensor is considered to be associated with the sequential actuation wheel or the electric motor when it is sensitive to the rotation of the sequential actuation wheel, to the rotation of the electric motor, or to the rotation of another component, for example a transmission shaft, rotationally secured to the sequential actuation wheel or the electric motor.

The first angular position signal from the first angular position sensor can be a direct signal from a sensor or a complex signal calculated from the signal from a sensor and/or from the measurement of parameters related to the operation of the electric motor.

In fact, if it is possible to position a first angular position sensor on the electric motor, it is also possible, for example in the case of permanent-magnet brushless three-phase synchronous motors, to determine the angular position of the rotor via an algorithm based on the parameters of the motor, like the voltage or current of the various phases. Since the parameters of the motor are determined directly by the electronic command circuit of the motor, it is thus sufficient to make use of the information from this command with a processor, for example. The processor can then provide the signal which is used for forming the first angular position signal.

According to a characteristic of the invention, the first angular position sensor is a sensor with a continuously variable signal which is sensitive to a rotation of the actuation wheel over an angular range of 360°. In other words, the first angular position signal delivered by the sensor serves to continuously reflect the angular position of the sequential actuation wheel and in particular the instantaneous absolute angular position of the sequential actuation wheel over 360°.

It is also considered that the first angular position signal is continuously variable when the signal is a variable analog signal or a digital signal formed from a continuous succession of discrete values reflecting the instantaneous absolute angular position over one full turn of the sequential actuation wheel, with each angular position thus corresponding to one distinct value. The number of values in this case is preferably greater than or equal to 180 or greater than 360 so as to have a precision better than one degree of angle. It further serves to anticipate the arrival of the sequential actuation wheel in a preset angular position.

The sensor is thus distinguished from the sensor used in the tying gun from the document EP 0,763,323 which only issues a pulse signal when an indexing magnet passes before the sensor and which issues a null or constant signal for all positions of the sequential actuation wheel other than those marked by an indexing magnet.

The first angular sensor from the invention can be a magnetic or optical sensor. In a specific implementation, the first angular sensor can be a Hall effect sensor associated with at least one rotating magnet mounted on a shaft end of a shaft rotationally secured to at least one among the sequential actuation wheel and the electric motor, associated with the sequential actuation wheel. It can be the rotation shaft of the sequential actuation wheel or a shaft synchronized with the rotation shaft of the sequential actuation wheel.

In particular, the magnet can comprise two poles, North and South, mounted turning on a shaft end in a plane perpendicular to the shaft generating a turning magnetic field. The magnetic field, which is continuously variable with the angle of rotation, can be sensed by one or more magnetoresistance or Hall effect probes from the first angular sensor placed opposite the magnet along an axis parallel to the axis of rotation thereof.

According to another implementation possibility for the first angular position sensor, it can involve an optical angular sensor associated with a circular test pattern rotationally secured to the sequential actuation wheel. The test pattern may comprise, for example, a continuous succession of optical references so as to provide a first sampled signal of the angular position of the sequential actuation wheel. The circular test pattern can be carried by the sequential actuation wheel. In this case, it can involve an optical rotary encoder from the trade.

According to another implementation possibility for the first angular position sensor, suited to an apparatus in which the electric motor associated with the sequential actuation wheel is a permanent-magnet brushless three-phase synchronous motor, the first angular position sensor may comprise a measurement circuit for at least one among a voltage and current of the phases of the motor, and a calculation unit configured for establishing the first angular position signal based on a measurement signal from the measurement circuit.

Here the term calculation unit designates a processor, for example in the form of a dedicated integrated circuit, or in the form of a processor executing software. In particular, the relative angular position of the rotor of the motor can be established by a measurement that one given the instant of the voltage or current properties on each of the phases of the motor, where the measurement can be established on the basis of the parameters from the command signals sent to the phases of the motor by the electronic command circuit. From the position of the rotor, together with the mechanical reduction ratio of the motor to the sequential actuation wheel, it is thus possible to calculate the relative angular position of the sequential actuation wheel. This operation can be done by the calculation unit of the first angular position sensor. For example, it involves a processor together with a memory containing the value of the reduction ratio. It can in this case be associated with a reference sensor sensitive to a reference angular position of the sequential actuation wheel. The reference sensor can for example be a simple Hall effect sensor associated with an indexing magnet giving a singular angular reference for the sequential actuation wheel, for example at the beginning of the tying cycle. In this case, the calculation unit can be intended and configured for establishing the first angular position signal as a function of a measurement signal from the relative angular position of the rotor of the motor and of the reference angular position, with which to establish an absolute angular position of the sequential actuation wheel.

The first angular position signal delivered by the first angular position sensor communicates information about the instantaneous angular position of the sequential actuation wheel to the electronic command circuit of the motor. This information can thus be used for driving, for example, a progressive stop with decreasing speed until the sequential actuation wheel stops in predetermined angular positions. In particular the rotation speed of the motor can be locked to the angular position of the sequential actuation wheel. It can for example be locked for progressively decreasing with the approach to the desired stop position.

Such driving serves to avoid a sudden stop of the sequential actuation wheel while also reducing the overall time necessary for stopping thereof and for positioning thereof in the preset angular positions. The first angular position sensor thus serves to anticipate the command actions of the electric motor associated with the sequential actuation wheel, where these actions are done at the moment a position of the sequential actuation wheel is in a predetermined position. The predetermined positions of the sequential actuation wheel can be stored in advance in the electronic command circuit for the motor, and it is possible to change them or add to them without changing the mechanics of the tool. Each predetermined angular position of the sequential actuation wheel can lead to different actions in the command of the electric motor, since these positions are considered in the command software for the tool either for the implementation of the tying cycle, or for execution of specific commands.

The electronic command circuit for the motor may in fact comprise a dedicated processor or a processor driven by command software. The electronic command circuit for the motor may also comprise a memory for storing preset positions of the sequential access wheel associated with command phases of the motor. For example, predetermined positions of the sequential actuation wheel corresponding to a stopping of the rotation of the motor, a slowing of the motor or an acceleration of the motor may be stored.

The tie placement device can further comprise a second angular position sensor for the rotary twister, an electric motor associated with the rotary twister and an electronic command circuit for said electric motor associated with the rotary twister, where the command circuit is connected to the second angular position sensor and receives the second angular position signal from the second angular position sensor for driving of the motor depending on said second angular position sensor.

The electric motor associated with the rotary twister can be the electric motor connected to the transmission mechanism comprising the sequential actuation wheel. In this case, the electronic command circuit of the electric motor associated with the rotary twister is also the electronic command circuit connected to the first angular position sensor, meaning the electronic command circuit of the electric motor connected to the transmission mechanism comprising the sequential actuation wheel. It involves a single electric motor implementation which can selectively drive the sequential actuation wheel and the twister.

According to another possibility, the electric motor associated with the twister can be a distinct electric motor from the electric motor connected to the transmission mechanism comprising the first sequential actuation wheel.

In the case of an implementation with two motors, a single command circuit can be used for commanding and synchronizing the command of the motors for the sequential actuation wheel and the twister. The electronic command circuit then further receives the second angular position signal.

The second angular position sensor delivers a second angular position signal allowing the electronic command circuit of the electric motor associated with the twister to drive a stop of the rotation of the motor during a rotation phase driving the movement of the twister. Stopping the rotation can be driven such that the twister is aligned with the path of the tie wire at the moment of stopping.

The twister is considered aligned with the path of the tie wire when the tie wire feeders for the twister, meaning the feeder arms, or, as applicable, the tie-wire passage openings of the twister, are located in a position allowing the free passage of the tie wire during its travel to the fixed end of the guide and then intercepting the ends of the tie wire after severing thereof and during rotation of the twister.

Just like the first angular position sensor, the second angular position sensor may be a Hall effect sensor with continuously variable signal, sensitive to a rotation of a shaft rotationally secured with the twister. It may also be an optical sensor associated with a test pattern positioned around the shaft rotationally secured to the twister.

The second angular position sensor may also comprise a simple sensor like, for example, a Hall effect sensor with an indexing magnet signaling the passage of the angular position of a reference of the twister. In this case, the motor can be a permanent-magnet brushless three-phase synchronous motor in which the relative angular position of the rotor can be calculated, leading to the calculation of the absolute angular position of the twister by knowing the reduction ratio.

The signal from the second angular sensor may be continuously variable over an angular range of 360°. It can also be continuously variable over one or more angular ranges that are more limited, where each angular range changes continuously between a minimum value and a maximum value, where the latter is reached when an indexing magnet passes before the sensor in the example of using a Hall effect sensor. The one or more angular ranges over which the signal is continuously variable are greater than 20° and preferably greater than 40°. The second angular position sensor can be associated, for example, with two rotating magnets mounted symmetrically on a support in a plane perpendicular to the shaft rotationally secured to the twister, when the twister itself has a 180° axial symmetry.

The second angular position sensor is in this case sensitive to a variation of the magnetic field induced by the rotating magnets on the approach thereof during the rotation of the shaft by delivering a continuously variable signal over an angular range centered on each magnet. Since the twister is symmetric, the position of each magnet allows the twister to be positioned so that it is aligned with the path of the tie wire. Because the approach of the magnet can be detected, a sufficient deceleration of the motor can be anticipated for stopping it when the twister is aligned on the path of the tie wire. The tie can be tightened to within a half turn because of the axial symmetry of the twister.

Just as for the first angular position sensor, the second angular position signal from the second sensor can be considered continuously variable when it allows consideration of the angular position of the shaft with a precision of order one degree of angle over at least one angular range greater than 20° and preferably greater than 40°. The signal can be an analog signal or a digital signal representative of any angular position of the shaft.

The use of an analog Hall effect sensor, for example the DRV5053 from Texas Instruments, is possible and in this case the angular position of a magnet relative to the second angular position sensor of over 40° can be known. Preferably the magnet is positioned in the area of the axis of the twister. In fact, the closer the magnet is to the axis of rotation of the twister, the more extended the angular detection range thereof. With a more extended detection range, the arrival of the magnet opposite the second angular position sensor can be detected earlier. In the case of a symmetrically opposite disposition of two magnets, corresponding to an axial symmetry of the twister, it is possible to precisely know the position of one of the magnets over a 180° path corresponding to the axial symmetry of the twister; the second angular position signal is at the minimum value thereof when the two magnets are equally distant from the second angular sensor and the signal is at the maximum value thereof when the magnet is located facing the second angular position sensor.

As already discussed above, the electronic command circuit for the motor can be configured for at least one first stop phase of the rotation of the electric motor, during which the rotational speed of the electric motor is locked to the angular position of the sequential actuation wheel.

The locking takes place depending on the first angular position signal.

Such a stop phase also corresponds to a phase of the command process for the apparatus described later called final.

The rotation speed can in particular be locked for slowing on approaching a desired angular position with a stop at this angular position.

In particular, the first stop phase can be associated with the open position of the hook.

In other words, it involves a position of the sequential actuation wheel for which an actuation cam or an actuation roller comes to command the movement of a link causing a pivoting of the hook from the closed position thereof to the open position thereof. During the tying cycle, this angular position corresponds to the start and end of the cycle.

Further, and as previously mentioned, the advancing feeder for the tie wire can be a roller feeder, preferably comprising notches for driving the line without slipping. It may comprise a feed roller and a presser roller, where the presser roller is able to move between a closed position of the feed roller and a lifted position releasing a passage between the presser roller and the feed roller for stopping, for example, the feeding of the tie wire.

In this phase, a stop phase of the motor can also be associated with the raised position of the presser roller.

Such a stop phase allows, as necessary, better access to the presser roller, so as to facilitate cleaning of the roller or replacement thereof. It also allows placement of a new tie wire in the advancing feeder.

The presser roller may be actuated by a lever and a link pushed by a cam of the sequential actuation wheel.

Further, the sequential actuation wheel can be a gear wheel connected to the feed roller by a gear. In this case, the feed roller is driven continuously by the sequential actuation wheel. However, advancing of the tie wire is only operated when the sequential actuation wheel allows the presser roller and the feed roller to come close and therefore to press the tie wire onto the feed roller.

The stopped phases corresponding to the released position of the presser roller or to the open position of the hook can be provided during a rotation of the electric motor in a rotation direction in which the sequential actuation wheel is driven.

Stopped phases for a reverse rotation direction of the actuation motor are also conceivable, in particular when a shared motor drives the sequential drive wheel and the twister.

In particular, the electronic command circuit for the motor can additionally be configured for at least one second stop phase of the rotation of the electric motor during which the rotation speed of the electric motor is locked to an angular position of the twister, where the second stop phase is associated with the position of alignment of the twister with the wire guide, mentioned above. The second stop phase is distinct from the first stop phase.

During such a stop phase, the electronic command circuit of the motor makes use of the second angular position signal from the second angular position sensor associated with the twister.

A method for placement of a tie wire with an apparatus such as previously described may comprise the following steps:
a first phase comprising closure of the hook, advancing the tie wire to the end of the fixed guide, and cutting the tie wire where the electric motor associated with the rotation of the sequential actuation wheel is commanded by the first angular position signal from the sequential actuation wheel;
a second phase comprising actuation of the twister, where the electric motor associated with rotation of the twister is commanded by the second angular position signal from the twister;
a final phase comprising opening of the hook, positioning of the sequential actuation wheel in a tying cycle starting position, and then stopping rotation of the electric motor associated with the rotation of the sequential actuation wheel, where said electric motor is commanded and locked in rotation during the final phase by the first angular position signal from the sequential actuation wheel.

The positioning of the sequential actuation wheel in a tying cycle starting position makes it possible to immediately begin a new tying cycle in response to actuation of a trigger by the user.

The cycle starting position is a position in which the hook is open. Preferably, in this position, the tie wire already passes in part in the twister and already engages in part in the hook.

The first step of the process is understood as beginning with the sequential actuation wheel in the tying cycle starting position.

Preferably, the first phase may be accompanied by the closure of the hook. In this case, during the slowing and stopping phase of the electric motor associated with rotation of the sequential actuation wheel for closure of the hook, a rotation speed of the electric motor is locked to the angular position of the sequential actuation wheel. Such a stop corresponds to the “first stop phase” previously discussed.

The locking of the rotation speed of the motor, associated with the rotation of the sequential actuation wheel, to the angular position of the sequential actuation wheel by the first angular position signal in particular allows slowing the rotation speed for reaching the zero rotation speed at the same time as the arrival of the hook in closed position.

With this characteristic, the closed position may be reached with precision while increasing the general actuation speed.

With this feature, it is also possible to reduce the rotation speed of the motor more gradually, which may allow recovery of a very large portion of the kinetic energy of rotation. In fact, the motor may comprise a generator for slowing the rotation of the sequential actuation wheel and in this case sending the energy to the battery.

Similarly, the second phase of the process may comprise a phase of slowing and stopping the electric motor, accompanied by a positioning of the twister in a position aligned with the tie wire guide. In this case, during the slowing and stopping phase of the electric motor, a rotation speed of the electric motor is locked to an angular position of the twister. Such a stop corresponds to the “second stop phase” previously discussed.

The locking makes it possible in particular to reach simultaneously the stopping of the rotation of the motor and the aligned position of the twister.

Further, progressive stopping of the rotation of the electric motor associated with rotation of the twister, serves to reach the aligned position of the twister smoothly and quickly, without excessive stress on the mechanical components, while also avoiding an additional positioning phase of the twister.

It is also possible to add or modify preset angular positions without mechanically modifying the tool by modifying the driving software of the tool and the parameters entered in the memory such as new preferred predetermined angular positions. Furthermore, the tying cycle time can be reduced by an increase of the average rotation speed of the sequential actuation wheel and by the savings of an additional phase for positioning of the twister, while also reducing the harmful effects at the mechanical level from sudden starts and stops of the motor.

Other characteristics and advantages of the invention emerge from the description which follows and references the figures from the drawings. It is given for illustration and is nonlimiting.

### BRIEF DESCRIPTION OF THE DRAWINGS

FIG. 1 is a perspective of a tie placement apparatus conforming to the invention.

FIG. 2 shows the positioning of the apparatus from FIG. 1 around a branch before receiving a tie.

FIG. 3 is a view of the apparatus from FIG. 1 in which a front part of the housing and the electronic command circuit have been withdrawn.

FIG. 4 is a detailed perspective of the principal components of the tie placement apparatus and a transmission mechanism for the movement.

FIG. 5 is another perspective of components of the tie placement apparatus.

FIG. 6 is a diagram of rotational speed of an electric motor for the tie placement apparatus conforming to the invention giving a comparative example with the state-of-the-art and showing successive operations for the functioning of the apparatus from the invention during a tying cycle.

The figures are made at an arbitrary scale.

### DETAILED DESCRIPTION OF THE EMBODIMENTS OF THE INVENTION

In the following description, identical, similar or equivalent parts from different figures are labeled with the same reference signs in order to facilitate comparing one figure to another.

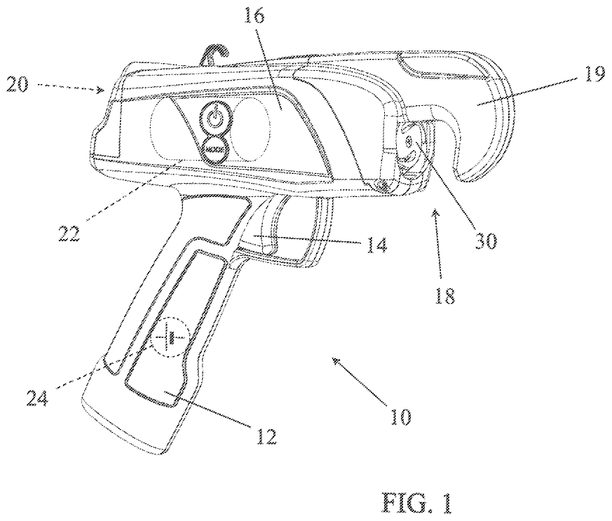

FIG. 1 is a perspective of the apparatus for placing ties. It has the shape of a tying gun 10 provided with a handgrip 12 and an actuation trigger 14. The handgrip 12 is secured to an apparatus body 16 provided with a tie placement head 18. The actuating handgrip is used to start a tie placement operation.

The tie placement head 18 has an end 19 forming a beak. An opposite end, at the rear of the handgrip 12, has an inlet 20 for tie wire. The inlet 20 for tie wire is an opening receiving a continuous tie wire, unwound from a tie wire coil, for example. The tie wire is not shown.

In a preferred embodiment, the apparatus body encloses a single electric motor 22 for the mechanical actuation of the tie placement head 18. The motor is suggested in broken line.

The motor is supplied with electric energy from a rechargeable battery 24 housed in the handgrip 12. The battery is also shown symbolically.

In the area of the beak 19 of the tie placement head 18, the presence of a twister 30 can be seen.

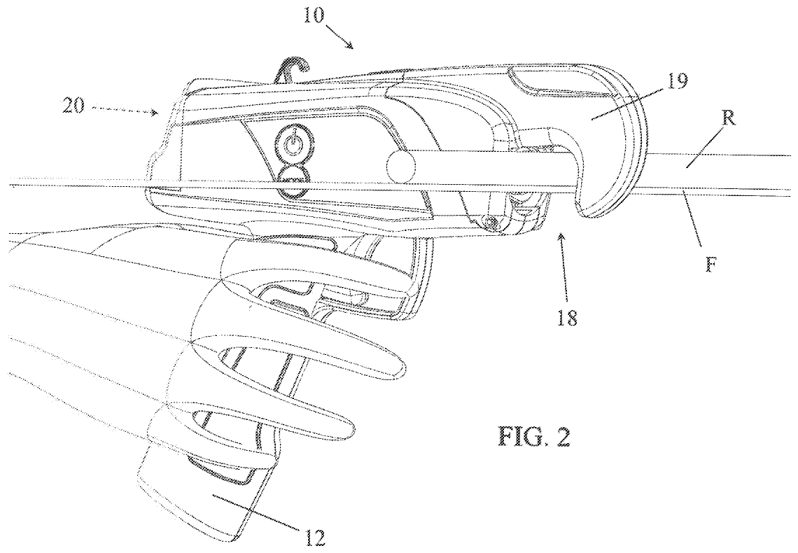

FIG. 2 shows the engagement of the beak 19 of the tie placement head 18 on a shoot R and training wire F to be secured by means of a tie. The tie is not shown.

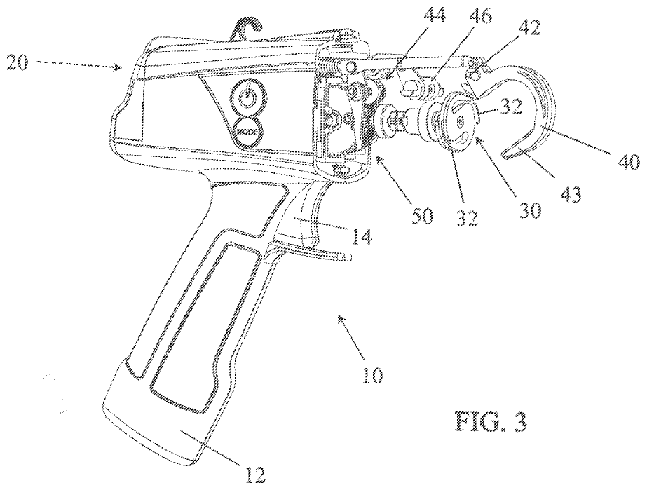

In FIG. 3, a portion of the housing of the tie placement head 18 was withdrawn so as to show the main components.

The presence of the rotary twister 30, already visible in FIG. 1 can be seen. The twister is provided with two grasping arms. They constitute tie wire feeders 32 intended to grab and feed a tie wire which will be twisted. For simplification, the tie wire is not shown on the figure.

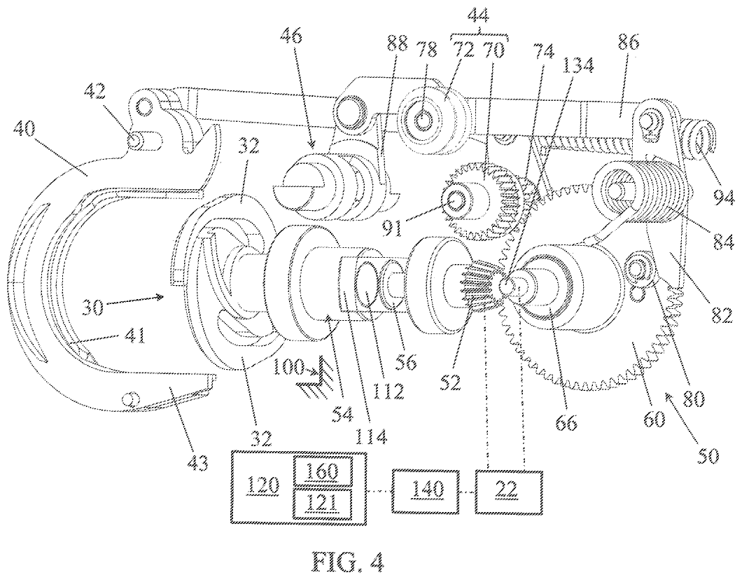

The presence of a hook 40 can be noted in the area of the twister. The hook is sheltered by a front part of the casing providing a beak 19 visible on FIGS. 1 and 2. The hook 40 is mounted pivoting on a pivot 42. It is shown in an open position allowing elements to be tied to be introduced under the beak of the tie placement head. In the closed position, shown in FIG. 4, the hook 40 encloses the beak.

A transmission mechanism for the movement 50 associated with the electric motor is used to transmit the movement from the motor to the twister 30. The movement of the motor is also transmitted to the hook 40, to an advancing feeder 44 for the tie wire, and to a blade 46 intended to cut the tie wire.

The transmission mechanism 50 is better seen in FIG. 4 which shows components of the mechanism in three dimensions in the position thereof in the tool. It comprises a drive pinion 52 for a longitudinal shaft 54 on which the twister 30 is mounted. The longitudinal shaft 54 is connected via the drive pinion 52 to an electric motor associated with the rotation of the twister.

In a preferred embodiment where the driving of the mechanical components of the apparatus is done by a single electric motor, the pinion 52 is connected to the longitudinal shaft 54 by the freewheel mechanism 56 with which to drive the longitudinal shaft 54 for only one direction of rotation of the motor. A rotation of the motor in a reverse rotation direction is free without driving the longitudinal shaft 54.

The transmission mechanism 50 further comprises a sequential actuation wheel 60 driven by an electric motor associated with the sequential actuation wheel.

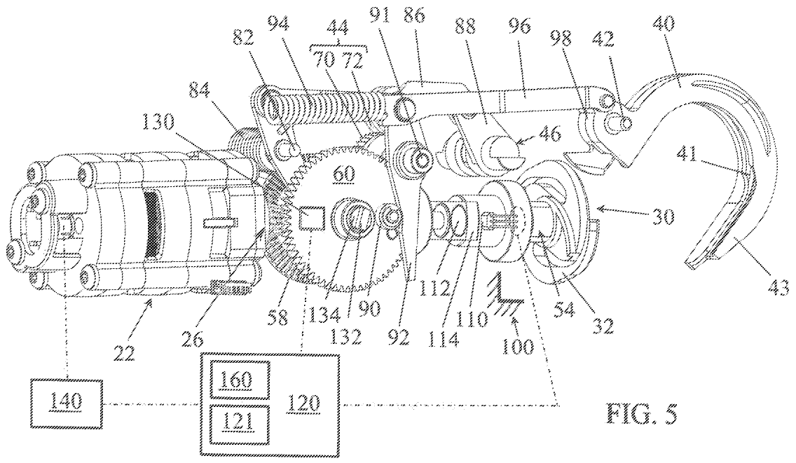

In the preferred embodiment, where the driving of the mechanical members of the apparatus is done by a single electric motor, said wheel is also coupled to the motor by a freewheel mechanism 66. The freewheel mechanism 66 serves to drive the sequential actuation wheel only for rotation of the motor in a direction opposite to that driving the twister. A coupling gear wheel serves to couple the electric motor 22 to the sequential actuation wheel 60 and to the pinion 52 for driving the twister. The coupling wheel is not visible in FIG. 4. It appears in FIG. 5 with the reference 58.

The sequential actuation wheel 60 is a gear wheel serving to actuate the tie wire advancing feeder 44 by gear. The advancing feeder 44 comprises a feed roller 70 together with the presser roller 72. The feed roller 70 is provided with teeth intended to improve feeding of the tie wire. It is mounted on a shaft 91, rotationally secured to a gear wheel 74 continuously engaged with the sequential actuation wheel 60.

Further, the sequential actuation wheel 60 has a first cam forming roller 80 on the side thereof. During rotation thereof, the first cam forming roller 80 comes to actuate a lever 82, loaded by a spring 84 and actuating via a first link 86 the blade 46 for cutting the wire. The blade 46 is formed by a rotary guillotine intersecting the path of the tie wire. The guillotine is also provided with an actuating lever 88 with a pivot receiving the first link 86.

The first drive 86 passes above the shaft 91 bearing the feed roller 70 and bears the presser roller 72. The presser roller is mounted in free rotation around a shaft 78 secured to the link 86. Thus, the movement of the first link 86 serve successively to advance the tie wire by holding it on the feed rollers 70 by a pressure of the press or roller 72 and then separating the press or roller and pivoting the blade of the guillotine for cutting the tie wire. This position is retained for FIG. 4.

FIG. 5 shows another function of the sequential actuation wheel which is that of actuating the hook 40. It further shows actuation of the transmission mechanism 50 by the motor 22 and via the conical pinion 26 on the motor shaft engaging with the conical wheel 58. This corresponds to the preferred embodiment in which only one motor is associated with both the sequential actuation wheel and rotation of the twister.

A second, cam forming, roller 90 is mounted on the sequential actuation wheel 60 on the surface opposite the one receiving the first cam forming roller. The second cam forming roller 90 is intended to engage with a second lever 92. The movement of the second lever 92 is a rotation around the shaft 91. It is transmitted to a second link 96 connected to a lever 98 of the hook 40 via a pivot 42. The second link 96 is loaded by a spring 94.

The interaction of the second roller 90 with the second lever 92 serves to move the hook 40 from the closed position thereof, visible in FIG. 4, towards the open position thereof, visible in FIG. 5. When the second roller 90 leaves the second lever 92, the spring 94 returns the second link 96 into a rest position in which the hook is closed.

It can be seen in FIGS. 4 and 5 that the hook 40 is provided with a groove 41 which provides a guide section for the tie wire.

The path of the tie wire thus passes between the feed roller 70 and the presser roller 72, then passes in the guillotine forming the blade 46 for engaging in the groove 41 of the hook and reaching a fixed guide end 100 located in the extension of the free end 43 of the hook 40 behind the twister 30.

The set of components located in the tie wire path—in particular the mechanical feeder 44, the guillotine forming the blade 46, the groove 41 of the hook, the twister 30 and the fixed guide end 100—make up a guide for a tie wire. The tie wire as such is an accessory of the apparatus and is not part of it. It is not shown. The twister 30 and in particular the prehensile arms, forming the feeder 32 of the twister 30, intercept the tie wire upstream from the hook, at the outlet of the guillotine 46 and downstream from the free end of the hook, before the fixed guide end 100.

A good interception of the tie wire is obtained by means of an appropriate angular positioning of the twister 30 shown in FIG. 4. This position is achieved because of the driving of the electric motor in which the speed thereof is locked to the angular position of the twister, in particular upon approaching the desired position.

The angular position of the twister is measured by means of the sensor 110 which constitutes the “second angular position sensor” in the meaning of the invention. The second angular position sensor is associated with two magnets 112 mounted on a support 114 rotationally secured with the twister 30 symmetrically about the longitudinal shaft 54 and in a plane perpendicular to the shaft. The second angular sensor 110 is preferably an analog sensor. It involves a Hall effect sensor or a magnetoresistance sensitive to variations of a magnetic field produced by each of the two magnets 112. The magnetic field is a maximum when one of the magnets 112 is closest to the sensor, but the sensor starts to deliver a signal upon the approach of a magnet, or reciprocally as it moves away. Thus, during one full turn of the shaft, the second angular position signal emitted by the irregular sensor 110 passes through two maxima respectively for the two magnets diametrically opposed about the longitudinal shaft 54. The maximum signal gives the precise position of the twister in rest position.

The signal passes continuously by a minimum when the two magnets are more than 20° away from the angular sensor 110. It is thus possible to anticipate the arrival of a magnet and consequently to reduce the speed of the motor so as to stop it at the moment when the magnet arrives opposite the sensor, without then overshooting the position thereof.

It is thus appropriate to note that it is possible in this condition to angularly anticipate during each full turn of the twister the arrival of two characteristic positions, since the twister must stop precisely at the end of the twisting cycle on one of these positions without the motor having been previously stopped for restarting at reduced speed towards the following position. Considering the number of twists to be made, the successive detection of the stop positions thus serves to progressively reduce the speed of the motor for just stopping precisely during the last turn in the stopped position of the twister.

The sensor 110 is connected to an electronic command circuit 120 of the motor 22 which makes use of the variations of the second angular position signal for locking the rotation speed of the motor and for driving a stop of the twister in a position aligned with the tie wire guide and in particular aligned with a portion of the guide made up by the hook 40. Stopping of the twister is preceded by phase of slowing during which the speed thereof decreases as the stop position is approached. One or more stop positions can be stored in a memory 121 of the electronic command circuit.

The electronic command circuit 120 of the motor 22 also receives a signal, as it happens the first angular position signal, from another sensor 130 which constitutes the “first angular position sensor” in the meaning of the invention. It can be seen schematically on FIG. 5.

The first angular position sensor 130 is preferably a sensor with one or preferably several Hall effect probes. For example, it involves a sensor of the type marketed by MPS under the catalog number MP9960.

The first angular position sensor 130 is associated with a magnet 132 mounted on a shaft 134 rotationally secured with the sequential actuation wheel 60. The magnet 132 has two magnetic poles North and South both positioned in a single plane perpendicular to the axis of the shaft 134. The shaft 134 in question is a shaft which receives the sequential actuation wheel and the coupling gear wheel 58 engaged with the drive motor.

The rotation of the shaft 134 and the magnet 132 with the sequential actuation wheel 60 creates a variable magnetic field near the first angular position sensor 130 which is converted by the first angular position sensor 130 into angular position data about the sequential actuation wheel. This signal is provided to the electronic command circuit 120 of the motor 22 in order to lock the speed of the motor to the angular position of the sequential actuation wheel and in order to cause shutdown phases of the motor when it is operated with one direction of rotation driving the sequential actuation wheel 60, including for positions distinct from those of the actuation of the cams 80 and 90.

In another embodiment, the first angular position sensor 130 may comprise a simple sensor, for example a Hall effect sensor associated with an indexing magnet for the sequential actuation wheel, indicating an angular reference position like for example the tying cycle start position. The signal for the reference angular position is then combined with a measurement 140 of the characteristics of the phases of the motor such as for example the voltage, giving an angular position relative to the sensor of the motor 22, where all of this is calculated with the reduction properties in a processor 160 of the electronic command circuit 120 in order to produce the first angular position signal. In this function, the processor 160 is also part of the first angular position sensor.

Two specific stop positions are in particular conceivable. It involves both one position, shown in FIG. 5, in which the hook 40 is at the farthest open position thereof, and also a position, shown in FIG. 4, in which the presser roller 72 is lifted from the feed rollers 70 in a movement participating in cutting the line.

The open position of the hook is an important position in which the elements to be attached can be inserted in the tie placement head 18.

The raised position of the roller is a position facilitating cleaning of the mechanical feeder 44 and, as needed, the replacement of the presser roller 72. It also serves to engage a tie wire in the advancing feeder 44 or to remove a tie wire from it that stayed caught.

The selection of stop and maintenance positions can be done by a command interface on the body of the placement apparatus visible for example in FIGS. 1 to 3, in particular with a “MODE” button which is used to select specific preestablished actions, leading to commands for the motor via the electronic command circuit thereof and establishing a rotation of the sequential actuation wheel into a preset position. The stop and maintenance position selection can also be coupled with a specific actuation of the trigger 14, for example maintaining pressure on this trigger for a predetermined time, for example for 2 seconds, longer than a normal actuation of the trigger.

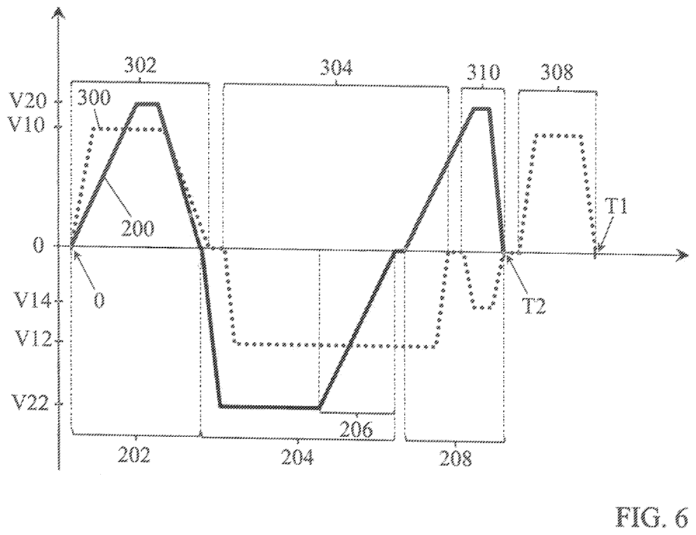

The operation of the apparatus 10 for tie placement is again shown in FIG. 6 which gives the speed setting 200 for the rotation speed of the motor during a tie placement cycle as a solid line. For comparison, the setting 300 for the tie placement cycle in the state-of-the-art constituted by the apparatus described in the document EP 0,763,323 is indicated by a dotted line.

In the diagram, the rotation speed is indicated on the ordinate. Positive values indicate a rotation direction of the electric motor associated with the rotation of the sequential actuation wheel. Negative values indicate an opposite rotation direction of the electric motor causing the rotation of the twister. It involves a preferred embodiment with a single motor. In the case where several motors are used, and in particular a distinct motor for actuation of the rotary twister, the negative values represent the velocity setting for the electric motor associated with the twister.

The abscissa shows the time value over a full cycle starting from the moment when the operator actuates the trigger 14 to make a tie. It is understood that at the moment 0 the hook is open and that the elements to be tied can be inserted into the tied placement head.

In a first phase 202, the electric motor associated with the sequential actuation wheel is actuated. Advancing of the line and closure of the hook are thus actuated simultaneously. The sequential actuation wheel continues to advance the line until it arrives at the end of the fixed guide. The first cam, meaning the first roller 80, comes into contact with the associated lever 82, in order to proceed with cutting the line by actuating the guillotine 46 and then separates from the lever 82 in order to return the presser roller 72 into pressing on the line because of the restoring spring 84 before stopping the motor. In this first phase, the acceleration and deceleration slopes are small, while giving a rotation setting to the motor up to a speed level V20, for example of 9000 RPM. The apparatus is thus less mechanically stressed.

The first phase 202 corresponds to a first phase 302 in the apparatus from the state-of-the-art.

In a second phase 204, the electric motor associated with rotation of the twister is actuated. This corresponds to a change of the direction of rotation of the motor in the case of the preferred embodiment with a single motor. During this phase, the rotary twister is rotated and the sequential actuation wheel then remains in a fixed angular position. The twister makes the tie by making a tighter or looser twist according to the adjustment preferred by the user. The acceleration of the motor at the beginning of this phase serves to reach a rotation speed level V22, where the absolute value thereof is, for example, 10,000 RPM.

The second phase, corresponding to the actuation of the twister, comprises a progressive and slow slowing phase 206 of the motor. The beginning of the slowing phase 206 is calculated by the microprocessor based on the number of turns to make to account for final turns made at a progressively slower speed until stopping thereof in a position in which the twister is aligned with the tie wire guide. Because of the progressive reduction of the speed, the tie wire twister can then be precisely positioned in the predetermined position thereof directly on stopping of the motor.

The second phase 204 of the apparatus for tie placement from the invention can be compared to a second actuation phase 304 of the twister in the apparatus from the state-of-the-art.

It can be noted that the maximum rotation speed V22 of the motor during the second phase 204 of the apparatus from the invention is higher than the speed V12 of the motor in the apparatus from the state-of-the-art. On the other hand, the length of the second phase 204, including the slowing phase 206, is shorter than the second phase 304 in the apparatus from the state-of-the-art.

After the second phase 204, the electric motor associated with the sequential actuation wheel is activated a final time. In the preferred embodiment, this corresponds to the change of direction of rotation of the single motor. In this final phase 208, the sequential actuation wheel completes the rotation thereof over one full turn. In the final phase 208, the twister is stopped, and the hook 40 is brought back to the initial open position thereof by means of the second roller 90 acting on the lever 92 while actuating the tie wire feeder to have the wire pass through the twister and partially advance it into the hook. At the end of the cycle, the hook is completely raised and the motor stopped, ready for a new tying cycle.

As a comparison, an additional phase 310, preceding a stopping phase 308, can be noted for the tie gun from the state-of-the-art. The additional phase 310 corresponds to a re-indexing of the twister considering the rapid deceleration of the motor between the speed V12 at the moment of forming the twist and stopping thereof in the phase 304. This is due to the fact that the Hall effect sensor in the apparatus from the state-of-the-art gives a simple angular position pulse for the shaft of the twister at the moment when the twister reaches this position. Thus, during the shutdown of the motor, the twister is not precisely positioned considering the mechanical inertia thereof. The additional phase 310 thus is used to command the rotation of the twister with a speed V14 slower than the speed V12 at the time of the formation of the twist. The stop occurs upon detection of the next magnet. The rotational energy is thus much smaller and it is easier to precisely position the twister upon stopping the motor.

Since the motor for the tie gun from the state-of-the-art is, as already indicated, a direct-current motor, rotation speeds thereof are slower than a permanent-magnet three-phase synchronous motor and it is more difficult to manage the slow acceleration and deceleration slopes as shown by the phases 302, 304, 308 and 310 of the tying cycle for this apparatus. The speed levels V10, V12 and V14 are, for example and respectively, 7400, 6000 and 3500 RPM.

It can also be noted that in the state of-the-art the total length T1 of the cycle is of order 500 ms, but since it involves a direct-current motor it can vary according to values from 450 ms when the battery is fully charged to 550 ms when it is discharged but still allowing the execution of a tying cycle. It is longer than the total cycle length T2 obtained with the tie placement apparatus from the invention which is of order 400 ms. The use of both a permanent-magnet three-phase synchronous motor having a higher rotation speed capacity, locking of the speed thereof and the use of two sensors giving continuous angular positions of the main components serves, by anticipating the position thereof, to accelerate the average speed of the cycle while controlling the acceleration and deceleration phases of the motor. The operation is clearly faster but also easier on the mechanics, improving the life and reliability thereof. It can further be noted that the digital control of the motor is insensitive to the state of charge of the battery. Thus, the values of T1 are nearly identical whatever this charge status is.

1. A tie placement apparatus, comprising:
a wire guide for tie wire, extending between a wire inlet and a fixed guide end;
a pivoting hook having one free hook end, where the hook forms a segment of the wire guide and pivots freely between an open position in which the free hook end is separated from the fixed guide end, and a closed position in which the free hook end is aligned with the fixed guide end;
a mechanical tie wire feeder disposed upstream from the hook;
a wire severing blade, where the blade is arranged downstream from the hook;
a rotary twister with tie wire feeders arranged upstream and downstream from the hook, and downstream from the blade, where the feeders are configured for intercepting a tie wire in an alignment position of the rotary twister with the wire guide;
an electric motor connected to a transmission mechanism comprising a sequential actuation wheel for the hook and the blade;
a first angular position sensor of the sequential actuation wheel, configured for delivering a first continuously variable angular position signal over a 360° angular range of rotation of the sequential actuation wheel, where the first angular position sensor is associated with at least one among the sequential actuation wheel and the electric motor;
an electronic command circuit for the electric motor connected to the first angular position sensor and receiving the first angular position signal from the angular position sensor, in order to drive the motor as a function of said first angular position signal.

2. The apparatus according to claim 1, wherein the first angular position sensor is a Hall effect sensor associated with at least one rotating magnet mounted on a shaft end of a shaft rotationally secured to at least one among the sequential actuation wheel and the electric motor.

3. The apparatus according to claim 1, wherein the electric motor is a permanent-magnet brushless three-phase synchronous motor, and wherein the first angular position sensor comprises a measurement circuit for at least one among a voltage and current of the phases of the motor, and a calculation unit configured for establishing the first angular position signal based on a measurement signal from the measurement circuit.

4. The apparatus according to claim 1, wherein the electronic command circuit for the electric motor comprises a memory for storing preset positions of the sequential access wheel associated with command phases of the motor.

5. The apparatus according to claim 1, further comprising, a second angular position sensor for the rotary twister, an electric motor associated with the rotary twister and an electronic command circuit for said electric motor associated with the rotary twister, where the electronic command circuit of said electric motor associated with the rotary twister is connected to the second angular position sensor and receives the second angular position signal from the second angular position sensor for driving of the motor depending on said second angular position sensor.

6. The apparatus according to claim 5, wherein the electric motor associated with the rotary twister is the electric motor connected to the transmission mechanism comprising the sequential actuation wheel and wherein the electronic command circuit of the electric motor associated with the rotary twister is the electronic command circuit connected to the first angular position sensor.

7. The apparatus according to claim 5, wherein, the electric motor associated with the rotary twister is a distinct electric motor from the electric motor connected to the transmission mechanism comprising the first sequential actuation wheel.

8. The apparatus according to claim 5, wherein, the second angular position sensor is a Hall effect sensor with continuously variable signal, sensitive to a rotation of a shaft rotationally secured with the twister.

9. The apparatus according to claim 5, wherein, the second angular position sensor is associated with two magnets mounted symmetrically on a support in a plane perpendicular to the shaft rotationally secured with the twister.

10. The apparatus according to claim 1, wherein the electronic command circuit of the electric motor connected to the transmission mechanism, respectively the electronic command circuit of the electric motor associated with the twister, is configured for at least one first stop phase of the rotation of the electric motor connected to the transmission mechanism, respectively the electric motor associated with the twister, during which the rotational speed is locked to the angular position of the sequential actuation wheel.

11. The apparatus according to claim 10, wherein the first stop phase is associated with the closed position of the hook.

12. The apparatus according to claim 10, wherein the advancing feeder for the tie wire comprises a feed roller and a presser roller, where the presser roller is able to move between a position close to the feed roller and a lifted position releasing a passage between the presser roller and the feed roller, and wherein a stop phase of the motor is associated with the raised position of the presser roller.

13. The apparatus according to claim 1, wherein the electronic command circuit of the electric motor connected to the transmission mechanism, respectively the electronic command circuit of the electric motor associated with the twister, is further configured for at least one second stop phase of the rotation of the electric motor connected to the transmission mechanism, respectively the electric motor associated with the twister, during which the rotational speed is locked to the angular position of the twister, where the second stop phase is associated with the position of alignment of the twister with the wire guide.

14. The apparatus according to claim 1, wherein the transmission mechanism comprises a freewheel coupling, coming selectively to engage with the sequential actuation wheel and the twister for opposite directions of rotation of the electric motor.

15. The apparatus according to claim 12, wherein the sequential actuation wheel is a gear wheel connected to the feed roller by a gear.
